(19) United States
(12) Patent Application Publication
(10) Pub. No.: US 2008/0238947 A1
(43) Pub. Date: Oct. 2, 2008

(54) System and method for non-linear magnification of images

(76) Inventors: T. Alan Keahey, Naperville, IL (US); Craig R. Barnes, Forest Park, IL (US)

Correspondence Address: PATENT GROUP;C/O DLA PIPER US LLP, 203 N. LASALLE ST., SUITE 1900, CHICAGO, IL, 60601, US

(21) Appl. No.: 11/728,691

(22) Filed: Mar. 27, 2007

(51) Int. Cl. G09G 5/00

(52) U.S. Cl. 345/666

(57) ABSTRACT

A system for performing non-linear magnification of an image includes a graphics processing unit that runs a shader program featuring a magnification algorithm. The magnification algorithm calculates an index using a position of a pixel and the center of magnification as well as the radius of magnification. The index is used to access a Lookup Table to determine the displacement of the pixel. A magnification factor is also applied to the pixel as is a transparency factor and a border texture map to restrict pixel displacement.

### FIELD OF THE INVENTION

The present invention relates generally to computer graphics and, more particularly, to a system and method for non-linear magnification of images.

### BACKGROUND OF THE INVENTION

Due to the growth of computing power, users are demanding more and more information from computers, and want the information provided in a visually useful form. Computers typically use a computer monitor as a display device. A problem with such two-dimensional displays is that a full image which is moderately complex may not be displayable all at once with the detail necessary. This may be due to the resolution of the information in the image and the resolution and size of the display surface. This problem is normally referred to as the “screen real estate problem.”

When a full image is not displayable on the monitor in its entirety, the displayable image which is substituted for the full image is often either a detail image or a global image, or a combination of the two. A global image is the full image with resolution removed to allow the entire image to fit onto the display surface of the display device. Of course, the resolution might be so low that details are not available from this substituted image. A detail image shows the details, but only of a portion of the full image. With a detail image, the details of the image are available, but the global context of the details are lost. If a combination is used, the connection between the detail image and the global image will not be visually apparent, especially where the detailed image obscures more of the global image than is shown in the detailed image. As a result, while the above solutions are suitable for a large number of visual display applications, they are less effective where the visual information is spatially related, such as maps, newspapers and the like.

A recent solution to the “screen real estate problem” is the application of “detail-in-context” presentation techniques for the display of large surface area media, such as maps. Detail-in-context presentations, also known as non-linear magnification or scaling, allow for magnification of a particular area of interest in an image while preserving visibility of the surrounding portion of the image. In other words, in non-linear magnification, selected areas are presented with an increased level of detail without the removal of contextual information from the original image. In general, non-linear magnification may be considered as a distorted view of a portion of the original image where the distortion is the result of the application of a “lens” like distortion function to the original image.

Non-linear magnification therefore works by scaling different parts of the image differently. Traditional distortion functions or magnification algorithms work by displacing and interpolating image pixels by applying a displacement mapping. These displacement algorithms compute the pixel displacement on the system central processing unit (CPU) before display. A disadvantage of such an approach, however, is that performance is compromised in that CPU's cannot perform the calculations of the algorithm fast enough to allow large, high resolution images to be manipulated by a user in real-time, such as by a graphical user interface (GUI). Furthermore, the speed at which the CPU can access texture memory is problematic in this regard. Maintenance of real-time interaction between the user and the system with regard to the non-linear magnification of large, high resolution images is desirable.

### BRIEF DESCRIPTION OF THE DRAWINGS

FIG. 1 is a block diagram of a computer system in an embodiment of the non-linear magnification system and method of the present invention;

FIG. 2 is a flow chart illustrating the inputs for the shader program of the GPU in an embodiment of the non-linear magnification system and method of the present invention;

FIG. 3 is a diagram illustrating the vector P used in the magnification algorithm of the non-linear magnification system and method of FIG. 2;

FIG. 4 is an example of a Lookup Table used in the magnification algorithm of the non-linear magnification system and method of FIG. 2;

FIG. 5 is a diagram illustrating the boundary used in the magnification algorithm of the non-linear magnification system and method of FIG. 2;

FIG. 6 is a diagram illustrating the alpha used in the magnification algorithm of the non-linear magnification system and method of FIG. 2;

FIG. 7 is an illustration of the graphical user interface (GUI) control in an embodiment of the non-linear magnification system and method of the invention;

FIGS. 8-11 are screen prints illustrating the use of the GUI of FIG. 7 in manipulating an image in real-time.

### DETAILED DESCRIPTION OF EMBODIMENTS

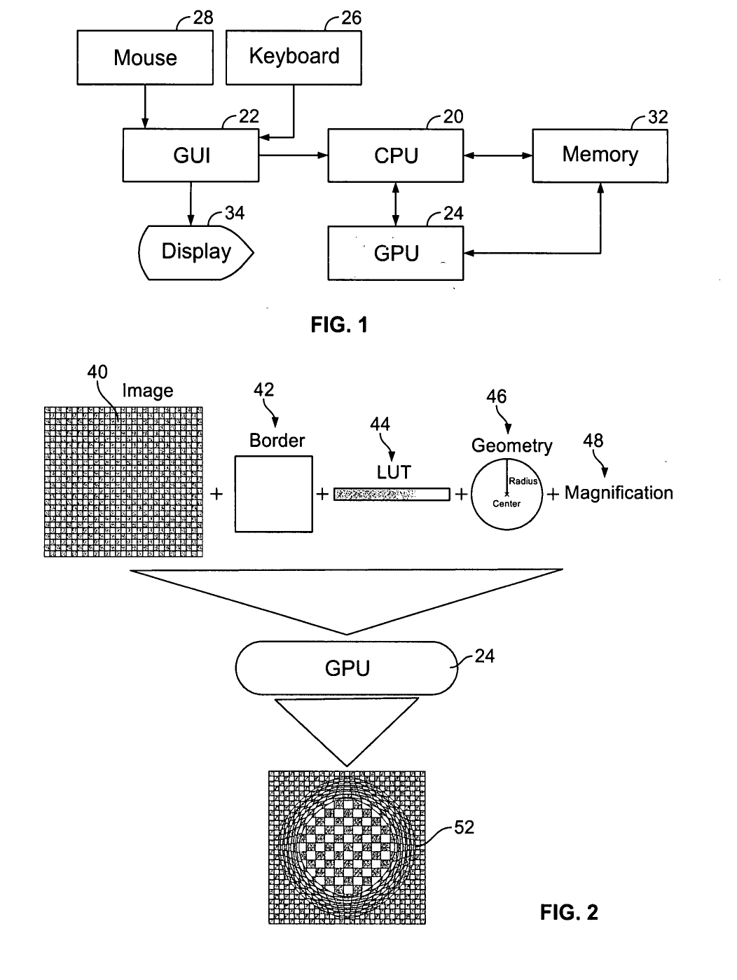

A computer system suitable for use in an embodiment of the non-linear magnification system and method of the present invention is illustrated in FIG. 1. The system features a central processing unit (CPU) 20 that communicates with a graphical user interface (GUI) 22 and a graphical processing unit (GPU) 24. The system features input devices for a user including a keyboard 26, a mouse 28 and possibly other input devices such as a trackball or the like (not shown). The CPU 20 may include dedicated coprocessors and memory devices. The system also includes memory 32, which may include RAM, ROM, databases, disk drives or other known memory devices. A display 34, such as a monitor, terminal or the like, displays information to the user. In a desktop personal computer, the GPU typically takes the form of a graphics card. A shader program is stored in the memory and accessed and run by the GPU. The use of the shader program, GPU and GUI, as well as the rest of the system, will be described in greater detail below. Of course, as understood in the art, the system may contain additional software and hardware a description of which is not necessary for an understanding of the invention.

As is known in the art, a GPU is a dedicated graphics rendering device for the system and is very efficient in manipulating and displaying computer graphics. The GPU features a highly parallel structure which makes it more effective than the CPU for a range of complex graphics algorithms.

As described previously, non-linear scaling or magnification works by scaling different parts of the image differently. As with traditional magnification algorithms, the magnification algorithm of the present invention works by displacing and interpolating image pixels. In the preferred embodiment of the invention, however, the GPU runs a shader program that includes the magnification algorithm. As a result the, the GPU performs the magnification calculations of the algorithm. Advances in GPU development allow the magnification calculations to be performed many times faster than if they were performed by the CPU. As a result, higher performance can be achieved which allows for high resolution images to be distorted and manipulated in real-time, such as by a GUI.

The increased speed of the magnification calculations allows for extremely high resolution images to be magnified and a minimal target frame rate of thirty frame per second may be maintained. Textures as large a 4K by 4K pixels can be magnified while maintaining this frame rate.

The shader program preferably is written in a shader programming language so that it can be incorporated into any program which has GPU shader support. An example of a suitable shader programming language is CG, which is a product of NVIDIA (www.nvidia.com). Alternative shader programming languages may be used instead.

The magnification algorithm of the shader program in a preferred embodiment of the system and method of the present invention will now be described. With reference to FIG. 2, the inputs to the magnification algorithm, and thus the shader program and GPU, include an image 40, a border 42, a Lookup Table (LUT) 44, a geometry 46 and a magnification factor 48. These inputs may be stored in the system memory (32 in FIG. 1).

The image 40 of FIG. 2 is simply the image upon which the non-linear magnification will be performed. An image could be, but is not limited to, a text document, a map or a graph. The border 42 defines the area of the image that will be magnified. In other words, the magnification will be constrained within the border. The magnification 48 is the magnification factor for the area within the border. The LUT 44, which is also illustrated in FIG. 4, is used to control magnification ramp up and plateau and its use will also be explained in greater detail below. The geometry 46 is the center of the magnification and the radius of a circle defining the magnification area.

The inputs may be summarized for use in the magnification algorithm as follows (with the corresponding input from FIG. 2 indicated in parentheses):

| | |
|---|---|
| Float radius | // radius of the magnification (Geometry 46) |
| Float beta | // magnification factor (Magnification 48) |
| Float [ ] LUT | // Array of float representing how far to displace the pixel |
| | based on distance from the center (LUT 44) |
| Tex2D border | // 2D texture defining the border of the outer edges of the |
| | displacement (Border 42) |
| Tex2D image | // input image to magnify (Image 40) |
| Vec2f uv | // current pixel location |
| Vec2f center | // location of center of magnification (Geometry 46) |

In addition to the above inputs, the magnification algorithm also uses the following variables:

| | |
|---|---|
| Vec3f P | // a 3-Space vector representing a vector from the |
| | current pixel location to the center of magnification |
| Float dist | // represents the distance from the current pixel |
| | location to the center of magnification; |
| Integer index | // the index in the LUT |
| Float f | // value from the LUT |
| Vec2f displacedUV | // a 2-Space vector representing the pixel |
| | displacement |
| Float alpha | // floating point value representing the transparency |
| | of the pixel |

Upon receiving the inputs, the GPU runs the shader program so that the following steps of the magnification algorithm are performed for every pixel in the area of the image surrounded by the border:

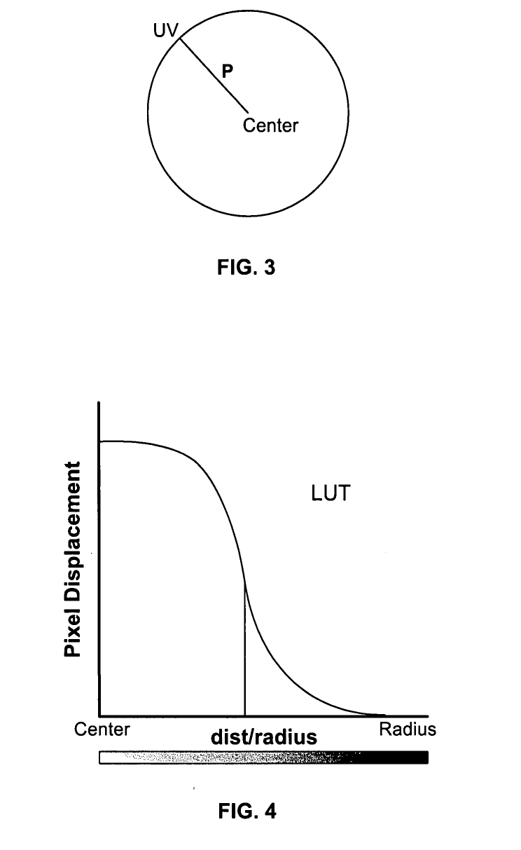

1. With reference to FIG. 3, a vector between the center of the magnification and the location of the current pixel is computed:

| | |
|---|---|
| Vec3f P = uv −center; | // Vector from the current pixel (uv) to |
| | center; |
| Float dist = vector length (P); | // distance from the current pixel to |
| | the center; |

2. The length of that vector, dist, is used to compute the index for accessing the magnification LUT. This table, an example of which is illustrated in FIG. 4, controls the magnitude or amount of the pixel displacement as a function of distance from the center of magnification. As illustrated in FIG. 4, a pixel near the center of the magnification is displaced the most, while pixels positioned on the outer edges of the magnification circle are displaced the least. Because the LUT is a input parameter to the shader program, different LUT's can be defined giving different types of magnification so that magnification can be altered in real-time.

| | |
|---|---|
| index = dist/radius; | // index into LUT |
| f = LUT[index]; | // LUT value |

3. The value obtained from the LUT represents a normalized pixel displacement. Using the value obtained from the LUT and the current magnification, a displacement uv coordinate (displacedUV) is computed. This displacement moves the location of the texture coordinate based on the equation:

displacedUV=uv−(beta*f)*P; //displace texture coordinate

The value obtained from the LUT represents a normalized pixel displacement. When this value is multiplied by the magnification factor (beta), the displacement can be increased or decreased depending on the value of beta. The displacement of the texture coordinate (uv) results in magnification, as the algorithm is automatically applied to all image pixels by the GPU when the shader program is executed.

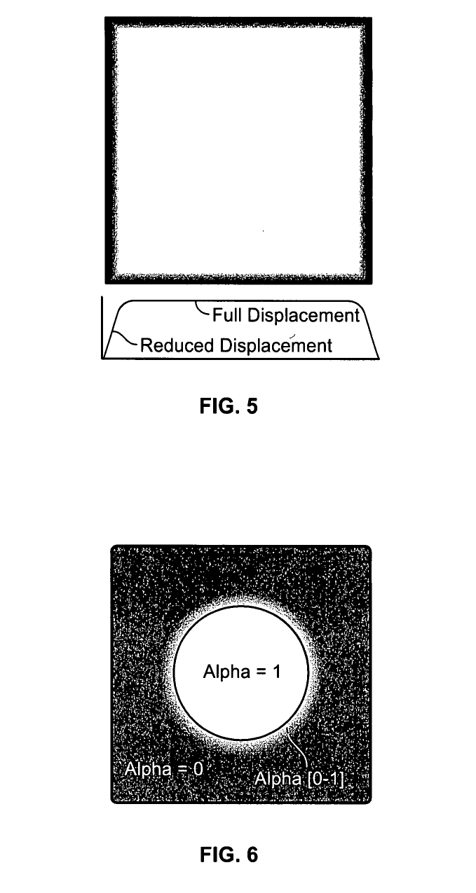

4. To prevent the displaced uv coordinate from extending outside of the image, the border, illustrated in FIG. 5 (and at 42 in FIG. 1) is used to dampen the displacement along the edges of the image. This damping is controlled by a input texture map which has intensity values of 0 where there is to be no displacement and 1 where full displacement is allowed. Values between 0 and 1 are displaced proportionally. One advantage of using a texture map to control the displacement is that arbitrary borders can easily be defined and changed in real-time.

| | |
|---|---|
| displacedUV = uv * (1 − border[uv]) + displacedUV * | // clamp |
| border[uv]; | displacement |
| | to border |

5. The final step allows a smooth transition at the boundary of the magnification radius and the non-magnified area. This is done by altering a transparency factor (alpha). The alpha value, which is illustrated in FIG. 6, controls the transparency of the magnified image created by the magnification algorithm. An alpha value of 0.0 means fully transparent, while an alpha value of 1.0 means fully opaque or solid. Alpha values between 0.0 and 1.0 allow for semitransparent pixels. The alpha therefore can be used by the shader program to mask out the magnification area from the rest of the image. In other words, the use of this alpha allows for two images to be composited by overlaying the magnified image over the other non-magnified image. This efficiently allows for a different image to be drawn in the magnified area than what is drawn outside of the magnified area. The alpha value is calculated using the distance value as follows:

| | |
|---|---|
| Float alpha; | // clamp radius |
| if (dist > radius) alpha = 0.0; | // outside of |
| | magnification is |
| | fully transparent |
| else if (dist < radius − radius*0.9) alpha = 1.0; | // inside border is fully |
| | opaque |
| else alpha = interpolate(radius, | // interpolate between |
| radius − radius*0.9) | transparent and opaque |

6. Finally, the magnified image is displayed on the display device (34 in FIG. 1) over the non-magnified image, as illustrated at 52 in FIG. 2:

return image[displacedUV]*alpha; //return magnified image

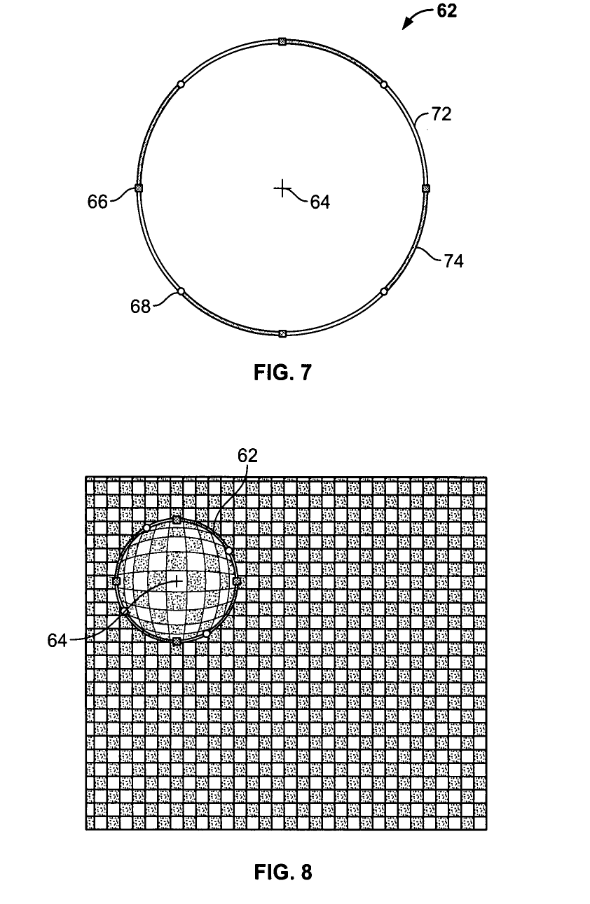

Control of the magnification is preferably handled by a GUI, illustrated at 22 in FIG. 1, a sample display of which is illustrated in FIG. 7. A circle, indicated in general at 62 in FIG. 7, defines the area of magnification. The GUI allows control of the position of the center, radius, and magnification parameters. With reference to FIG. 7, the center is moved by dragging the center 64 of the circle by using an input device such as a mouse (28 in FIG. 1). As will be explained in greater detail below, the radius of the circle 62 is control by dragging one of the four square radius controls 66 while magnification is controlled by dragging one of the round magnification controls 68.

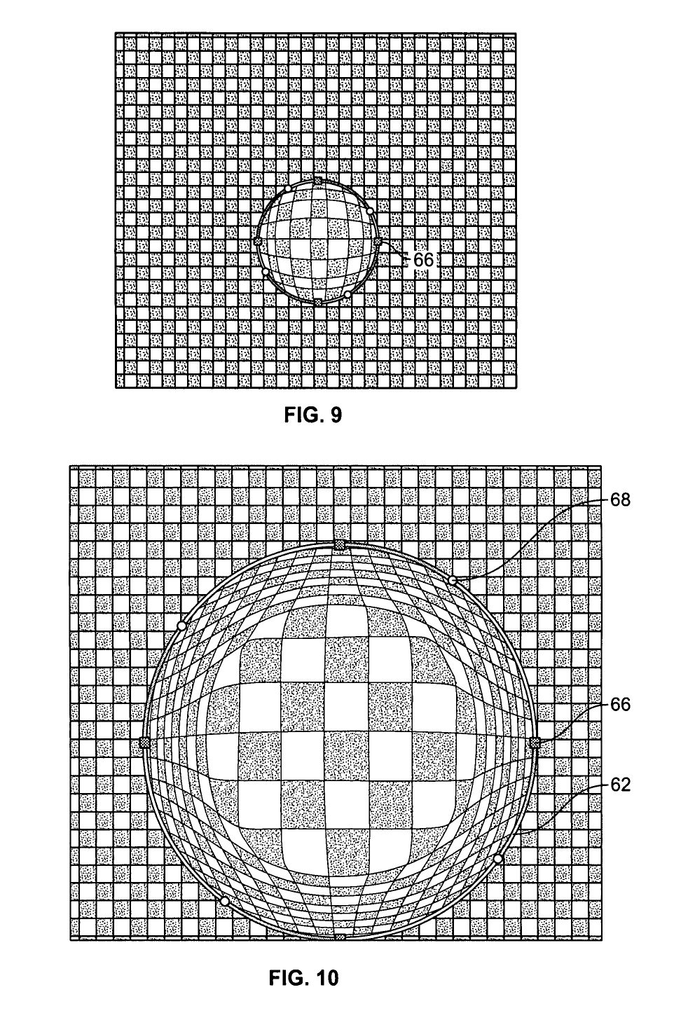

Use of the GUI of in the above embodiment of the invention will now be described with regard to FIGS. 8-11. FIG. 8 illustrates a sample screen print from the GUI where the a checkered image is subjected to non-linear magnification. As described with respect to FIG. 7, the circle 62 defines the magnification area and may be moved to a new position by dragging the center after the user clicks on the center 64 as illustrated in FIG. 8. FIG. 9 illustrates the circle after at has been dragged to a new position on the display.

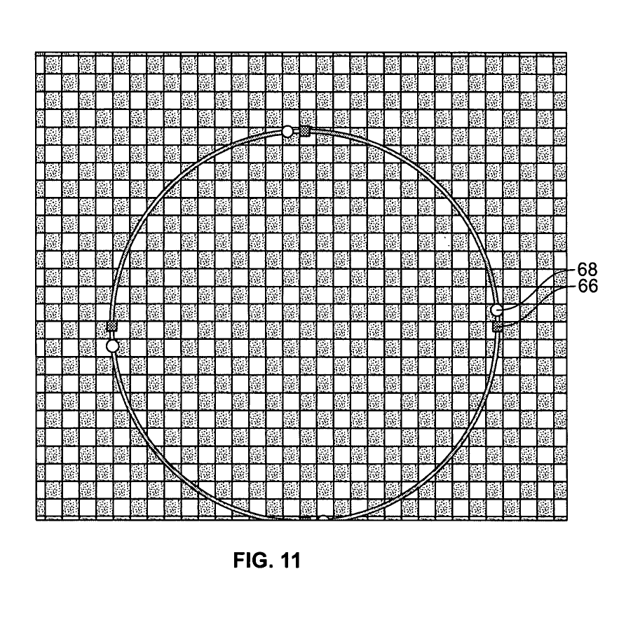

The user may adjust the radius of the circle, and therefore the area that is subjected to magnification, by dragging one of the square radius controls 66 in a direction perpendicular to the circle 62. More specifically, as illustrated in FIG. 9, the user first clicks on one of the square radius controls 66. If the user drags the control 66 away from the center of the circle, the radius of the circle is enlarged, as illustrated in FIG. 10.

The user adjusts the magnification of the area within the circle by clicking on one of the round magnification controls 68, as illustrated in FIG. 10. The user then moves the control either clockwise or counter-clockwise along the circle 62 to adjust the magnification. Portions of the circle are color coded to represent the degree of magnification. For example the lightly shaded sections of the circle, illustrated at 72 in FIG. 7, may be one color, yellow for example, while the darker shaded sections of the circle, illustrated at 74 in FIG. 7, may be another color, green for example. Moving one of the round magnification controls along the circle 62 moves the other three magnification controls along the circle the same amount and changes the amount of yellow or green that is visible on the circle along with a corresponding change in magnification. More specifically, moving a round magnification control 68 counter-clockwise increases the length of the sections of the circle that are yellow while simultaneously increasing the magnification level of the area within the circle and decreasing the length of the green sections. Moving the round magnification control 68 clockwise has the opposite effect. As a result, the more yellow that is present on the circle, and therefore the less green, the greater the level of magnification, and the less yellow that is present on the circle, and therefore the more green, the less the level of magnification in the circle. A user therefore can easily detect the level of magnification by glancing at the display device screen.

Returning to FIG. 10, after the user clicks on the round magnification control and drags it clockwise, the display in FIG. 11 results. That is, the round magnification control 66 has moved closer to the square radius control 68 (as is the case for the remaining three round magnification and square radius controls) so that the green segments of the circle increase in length while the yellow sections decrease in length to the point where they are nearly non-existent. As illustrated in FIG. 11, this corresponds to nearly zero magnification for the area within the circle. As should now be obvious, magnification may now be restored by clicking on and dragging the round magnitude control in the counter-clockwise direction.

The illustrated embodiment of the invention therefore provides faster magnification through use of a GPU. This permits the system to obtain large image distortion while maintaining real-time interaction through an easy to use GUI. The system provides arbitrary boundary definition and an arbitrary distortion profile using the LUT. The illustrated embodiment also provides multi-image composition through the use of alpha blending.

While embodiments of the invention have been shown and described, it will be apparent to those skilled in the art that changes and modifications may be made therein without departing from the spirit of the invention.

What is claimed is:

1. A system for performing non-linear magnification of an image comprising:
a) a display device;
b) a memory;
c) a processor in communication with said display device and said memory;
d) a magnification algorithm stored in said memory and run by said processor,
e) a Lookup Table stored in said memory;
f) a magnification factor stored in said memory; and
g) said magnification algorithm accessing the Lookup Table to determine displacement of pixels of the image and applying the displacement and the magnification factor to the pixels to obtain the non-linear magnification of the image for display on the display device.

2. The system of claim 1 wherein the processor is a graphical processing unit.

3. The system of claim 1 further comprising a graphical user interface in communication with said processor whereby a user can control the non-linear magnification of the image.

4. The system of claim 1 further comprising a border texture map stored in the memory and accessed by the magnification algorithm to restrict displacement of the pixels of the image.

5. The system of claim 1 further comprising a geometry including a radius of magnification and a center of magnification stored in the memory and accessed by the magnification algorithm to calculate an index that is used to access the Lookup Table.

6. The system of claim 1 wherein the magnification algorithm multiplies the magnification factor by a value retrieved from the Lookup Table to determine the displacement of the pixels of the image.

7. The system of claim 1 wherein said magnification algorithm is a shader program.

8. A method for performing non-linear magnification of an image comprising the steps of:
a) determining a location of a center of magnification for the image;
b) determining a location of a pixel of the image;
c) calculating a vector from the location of the center of magnification for the image to the location of the pixel;
d) determining the length of the vector;
e) calculating an index to a Lookup Table using the length of the vector;
f) accessing the Lookup Table using the index so that a normalized pixel displacement is obtained;
g) using the normalized pixel displacement to determine displacement of the pixel; and
h) applying the displacement and a magnification factor to the pixel.

9. The method of claim 8 further comprising the step of accessing a border texture map to restrict the displacement of the pixel of the image.

10. The method of claim 8 further comprising the step of multiplying the normalized pixel displacement by the magnification factor to determine the displacement of the pixel.

11. The method of claim 8 wherein a geometry of a magnification area is used to determine the location of the center of magnification for the image

12. The method of claim 11 wherein the geometry of a magnification area is also used to provide a radius of the magnification area that is used along with the length of the vector to calculate the index to the Lookup Table.

13. The method of claim 12 wherein the length of the vector is divided by the radius of the magnification area to determine the index to the Lookup Table.

14. The method of claim 8 further comprising the steps of repeating steps a) through h) to obtain a magnified image, determining a transparency factor based on the length of the vector and applying the transparency factor to the magnified image.

15. A machine-readable medium on which has been prerecorded a computer program which, when executed by a processor, performs the steps of:
a) determining a location of a center of magnification for an image;
b) determining a location of a pixel of the image;
c) calculating a vector from the location of the center of magnification for the image to the location of the pixel;
d) determining the length of the vector;
e) calculating an index to a Lookup Table using the length of the vector;
f) accessing the Lookup Table using the index so that a normalized pixel displacement is obtained;
g) using the normalized pixel displacement to determine a displacement of the pixel for non-linear magnification of the image; and
h) applying the displacement and a magnification factor to the pixel.

16. The medium of claim 15 wherein the processor further performs the step of accessing a border texture map to restrict the displacement of the pixel of the image.

17. The medium of claim 15 wherein the processor further performs step of multiplying the normalized pixel displacement by the magnification factor to determine the displacement of the pixel.

18. The medium of claim 15 wherein the processor uses a geometry of a magnification area to determine the location of the center of magnification for the image

19. The medium of claim 18 wherein the processor further uses the geometry of a magnification area is to provide a radius of the magnification area that is used along with the length of the vector to calculate the index to the Lookup Table.

20. The medium of claim 15 wherein the processor further performs the steps of repeating steps a) through h) to obtain a magnified image, determining a transparency factor based on the length of the vector and applying the transparency factor to the magnified image.
